(19) United States
(12) Patent Application Publication
(10) Pub. No.: US 2008/0216761 A1
(43) Pub. Date: Sep. 11, 2008

(54) CUBICLE CONSTRUCTION AND A COUPLING FOR SUCH A CUBICLE CONSTRUCTION

(75) Inventors: Renatus Ignatius Josephus FRANSEN, VLAARDINGEN (NL); Alexander Adrianus VAN LEEUWEN, DELFT (NL)

Correspondence Address: HOWREY LLP-EU, C/O IP DOCKETING DEPARTMENT, 2941 FAIRVIEW PARK DR., SUITE 200, FALLS CHURCH, VA, 22042, US

(73) Assignee: MAASLAND N.V., MAASSLUIS (NL)

(21) Appl. No.: 12/125,159

(22) Filed: May 22, 2008

Related U.S. Application Data
(63) Continuation of application No. PCT/EP2006/010786, filed on Nov. 10, 2006.

(30) Foreign Application Priority Data
Nov. 22, 2005 (NL) 1030494
May 19, 2006 (NL) 1031839

(51) Int. Cl. A01K 1/00

(52) U.S. Cl. 119/502

(57) ABSTRACT

A cubicle construction for forming a partition of an animal place has a partition element extending in the longitudinal direction of an animal place and a coupling for fastening the partition element to a support. The coupling comprises a support portion for fastening to the support and a partition element portion for fastening to the partition element, the partition element being movable in height by rotation about an axis of rotation. The coupling comprises a closing element for making the partition element portion detachable from the support portion via a movement of the partition element portion perpendicular to the axis of rotation.

### CROSS REFERENCE TO RELATED APPLICATIONS

This application is a continuation of International Application No. PCT/EP2006/010786 which was published under PCT Article 21(2) in English, the contents of which are hereby incorporated by reference in their entirety.

### BACKGROUND OF THE INVENTION

1. Field of the Invention

The present invention relates to a cubicle construction and more particularly to a construction for forming a partition of an animal place.

2. Description of the Related Art

A cubicle construction is known from European patent application EP 0447822 A2 the contents of which are hereby incorporated by reference in their entirety. This known device comprises a partition element extending in the longitudinal direction of the cubicle. This partition element is rotatable in the horizontal plane about a vertical support. The partition element is also movable in height about a horizontal axis. This prevents the animal from becoming injured when rising from a lying position.

In practice, actions on an animal regularly need to be performed by a farmer or a veterinary surgeon in a cubicle. For this purpose, it is practical to remove the partition element. For removing the partition element, several elements have to be detached in the case of the known device.

### BRIEF SUMMARY OF THE INVENTION

The present invention is aimed at providing an alternative cubicle construction. Such a construction may be capable of being disassembled in a simple manner. This is achieved by a cubicle construction comprising a partition element extending in the longitudinal direction of an animal place and being movable in height by rotation around an axis of rotation, a coupling for fastening the partition element to a support, which coupling comprises a support portion and a partition element portion. The partition element portion is arranged to be detachable from the support portion via a movement of the partition element portion perpendicular to the axis of rotation. A movable closing element allows detaching of the partition element portion from the support portion.

According to an advantageous embodiment of the invention, the coupling can be unlocked by means of one single closing element. The partition element portion with the partition element connected thereto is then detachable from the support by means of a simple movement. This can be done by one single person. It is understood that each partition may be provided with more than one coupling.

The partition element portion preferably comprises a stop for limiting the movement in height of the partition element. In this manner the movement in height of the partition element is limited, so that the animal is stimulated not to position itself under the partition element.

In a favorable embodiment, the closing element is pivoted to move about an axis perpendicular to the axis of rotation. This means that the closing element may remain connected to the cubicle construction and is still capable of being brought into a locking and an unlocking position.

In order to obtain a compact construction, the closing element may also comprise the stop. It is also advantageous that the coupling comprises a flexible bumper element that co-operates with the stop. This may be provided on the support portion.

It is furthermore advantageous if the support portion surrounds and clamps the flexible bumper element at least partially. The flexible bumper element is a wearing element that has to be replaced after some time has elapsed. In this manner it can be fastened with a minimum of components being used.

The support portion preferably comprises a bracket for securing the support portion on the support, the bracket comprising the axis of rotation. This provides a compact construction with a minimum amount of components being used.

In a favorable embodiment, the partition element portion comprises a rotation space for surrounding the axis of rotation, which rotation space comprises an aperture at its lower side. In this manner the partition element portion can be lifted from the support portion by means of a simple movement.

In a further advantageous embodiment, the partition element portion is designed as a single forged or cast metal portion. This embodiment allows a simple production.

The support portion preferably comprises two upright portions for carrying the axis of rotation. This makes it possible to design the axis of rotation as a simple straight bolt that is carried by the two upright portions. Alternatively, the axis may be provided by the base of a U-shaped bolt.

In a further particular embodiment, the closing element comprises a slotted hole and the slotted hole surrounds the closing element axis. In another particular embodiment, the closing element is shiftable along the closing element axis into a position in which rotation about the closing element axis is impeded or limited. In this manner the closing element is easily lockable in a particular position.

The invention further relates to a coupling suitable for the cubicle construction.

### BRIEF DESCRIPTION OF THE DRAWINGS

The invention will now be described by way of example with reference to an embodiment of a cubicle construction shown in the drawing, in which:

FIG. 1 is a schematic plan view of a cubicle construction according to the invention comprising an animal place surrounded by partition elements;

FIG. 2 shows a side view of a cubicle construction of FIG. 1 in which an animal is lying, and

FIG. 3 is a schematic perspective view of the coupling according to the invention, and

FIG. 4 is a front view of a particular embodiment of the closing element.

### DESCRIPTION OF ILLUSTRATIVE EMBODIMENTS

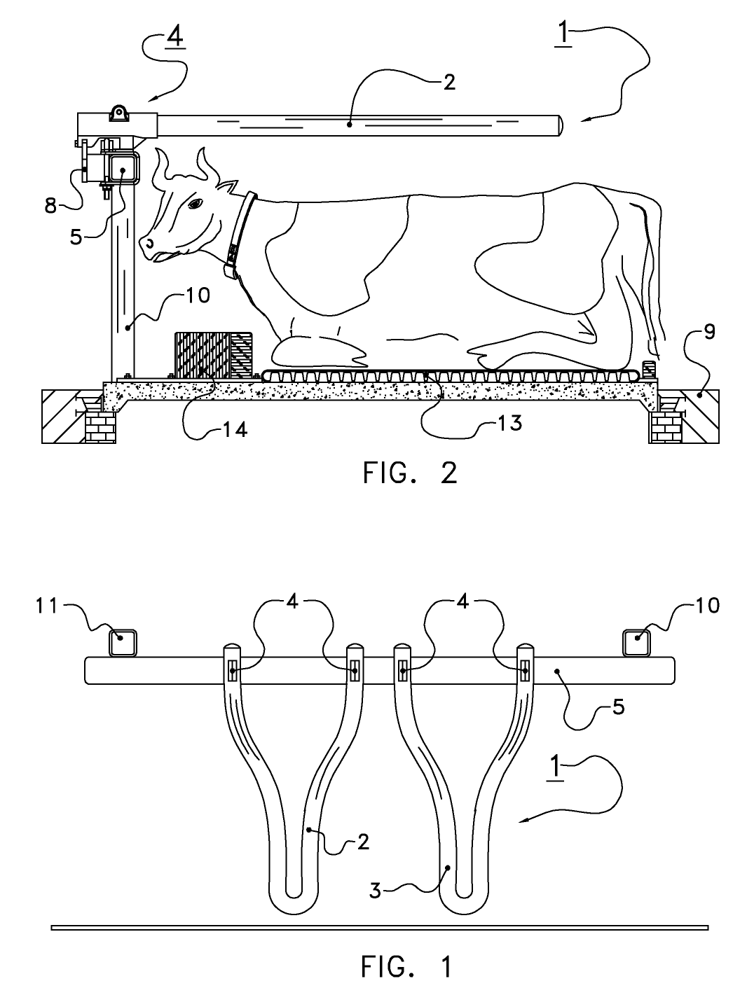

FIG. 1 shows a cubicle construction 1 according to the invention for forming a partition of an animal place, comprising a partition element 2, 3 extending in the longitudinal direction of an animal place and a coupling 4 for fastening the partition element 2, 3 to a support 5. In the depicted embodiment, each partition element 2, 3 has a pair of arms each provided with its own coupling 4, which coupling 4 comprises a support portion 6 for fastening to the support 5 and a partition element portion 7 for fastening to the partition element 2, 3. The partition element 2, 3 is movable in height by rotation about an axis of rotation 21. The coupling 4 comprises a closing element 8 for making the partition element portion 7 detachable from the support portion 6 by means of a movement of the partition element portion 7 perpendicular to the axis of rotation 21. The partition element portion 7 comprises a stop for limiting the movement in height of the partition element 2, 3. The animal place is located between two partition elements 2, 3. The partition element 2, 3 is described in detail in European patent application EP 1579760 the contents of which are hereby incorporated by reference in their entirety.

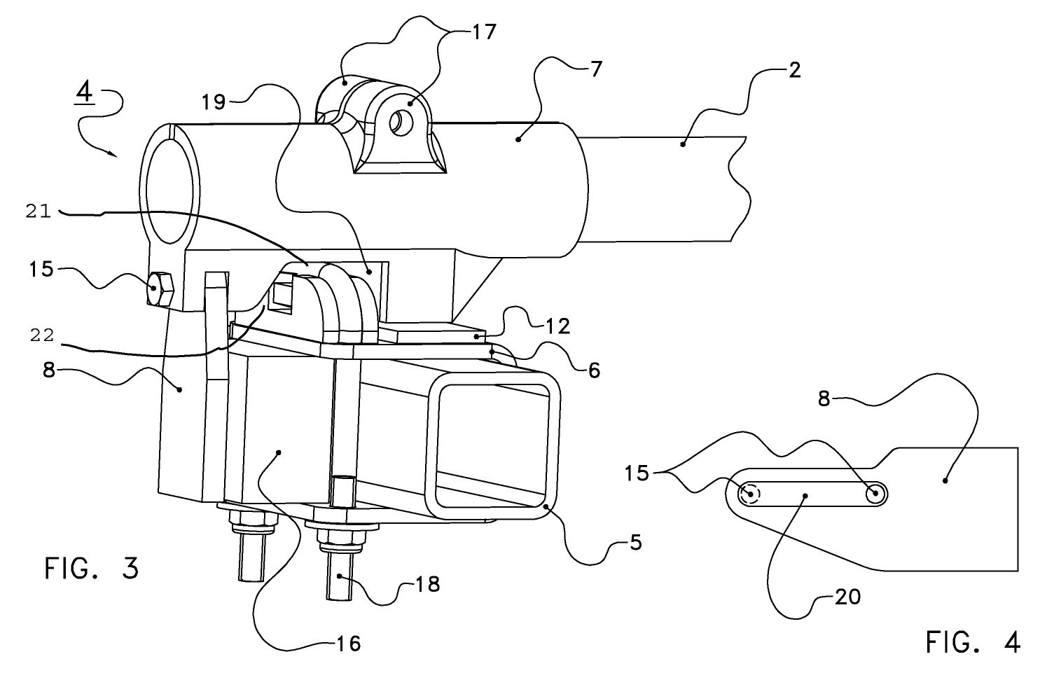

FIG. 2 is a side view of a cubicle construction 1 of FIG. 1, in which an animal is lying. At the rear side of the animal there is located a walking passage 9 designed as a grid floor. The partition elements 2, 3 are fastened to a support 5 designed as a horizontal box girder supporting several partition elements 2, 3. Two posts 10, 11 carry the box girder 5. The partition elements 2, 3 are shown in the inoperative position, i.e. in a position in which they are orientated horizontally and rest on a support stop 12 (FIG. 3). The animal place further comprises a mattress 13 and a knee barrier 14 for limiting the passage of the animal in the longitudinal direction of the cubicle.

FIG. 3 is a more detailed view of the coupling 4. Here, the closing element 8 is rotatably disposed about a closing element axis 15 perpendicular to the axis of rotation. The closing element axis 15 is designed as a simple bolt. The closing element 8 also comprises the stop. The coupling 4 further comprises a flexible bumper element 16 that co-operates with the stop, the support portion 6 surrounding and clamping the flexible bumper element 16 at least partially. The partition element portion 7 can be clamped on the end of the partition element 2 by means of two eyes 17 disposed on the upper side of the partition element portion 7 and a non-shown bolt. The support portion 6 comprises an inverted u-shaped bracket 18 for securing the support portion 6 on the support 5, the base of the bracket 18 comprising the axis of rotation. It will be immediately evident to the skilled person that other arrangements of the axis of rotation may be provided. The partition element portion 7 comprises a rotation space 19 for surrounding the axis of rotation, which rotation space 19 comprises an aperture 22 at its lower side. As shown, the partition element portion 7 is designed as a single forged or cast metal portion.

In a non-shown embodiment, the partition element portion 7 consists of two separate metal halves that are clamped together by means of bolts. In the latter embodiment, the closing element axis 15 is constituted by a small bar that is clamped in the recesses between the two halves.

When disposed in a cubicle construction 1, the partition element with the partition element portion 7 connected thereto is capable of rotating in vertical direction about the axis of rotation 21 until the closing element 8 presses against the flexible bumper element 16. This makes it possible for an animal that wishes to rise from a lying position to get up without being hampered too much.

In order to uncouple the partition element 2, 3 from the support 5, the following procedure is followed: first the closing element 8 is rotated about the closing element axis 15, so that the coupling 4 is unlocked. When the two couplings 4 of a partition element 2, 3 have been unlocked, the partition element 2, 3 is moved perpendicular to the axis of rotation 21 in the direction of the walking passage 9 until the portion of the bracket 18 that forms the axis of rotation 21 is located over the aperture 22 of the rotation space 19. The entire partition element 2, 3 including the partition element portion 7 can now be lifted in a simple manner from the support portion 6.

FIG. 4 shows a particular embodiment of the closing element 8. This embodiment comprises a slotted hole 20 that surrounds the closing element axis 15. The closing element 8 is shiftable along the closing element axis 15 into a position in which rotation about the closing element axis 15 is impeded or limited. For this purpose, there is made a recess at one side. In its locked position, the closing element 8 points downwards and the closing element axis 15 is in the position as indicated by the cross-section in the form of an interrupted line. When unlocking the coupling 4, the closing element 8 is rotated 90 degrees and subsequently shifted, after which the closing element axis 15 is located in the position as indicated in FIG. 4 by the cross-section in the form of an uninterrupted line. In this position, the flattened upper side of the closing element 8 forms a stop against the partition element portion 7, so that it is no longer possible for the closing element 8 to rotate about the closing element axis 15.

The invention is not limited to the embodiments shown. The person skilled in the art will be able to apply various modifications and adaptations without departing from the spirit and scope of the invention, the scope of protection for the invention being determined by the accompanying claims.

What is claimed is:

1. A cubicle construction forming a partition of an animal place, comprising:
a partition element extending in a longitudinal direction of an animal place and being movable in height by rotation around an axis of rotation;
a coupling for fastening the partition element to a support, which coupling comprises a support portion and a partition element portion
the partition element portion being detachable from the support portion via a movement of the partition element portion perpendicular to the axis of rotation; and
a closing element, movable to allow detaching of the partition element portion from the support portion.

2. A cubicle construction as claimed in claim 1, wherein the partition element portion comprises a stop for limiting the movement in height of the partition element.

3. A cubicle construction as claimed in claim 1, wherein the closing element is movable about a closing element axis perpendicular to the axis of rotation.

4. A cubicle construction as claimed in claim 2, wherein the closing element comprises the stop.

5. A cubicle construction as claimed in claim 4, wherein the coupling comprises a flexible bumper element that co-operates with the stop.

6. A cubicle construction as claimed in claim 5, wherein the support portion at least partially surrounds and clamps the flexible bumper element.

7. A cubicle construction as claimed in claim 1, wherein the support portion comprises a bracket for securing the support portion on the support, the bracket comprising the axis of rotation.

8. A cubicle construction as claimed in claim 1, wherein the partition element portion comprises a rotation space for surrounding the axis of rotation, which rotation space comprises an aperture at its lower side by which the partition element portion may be detached from the support portion.

9. A cubicle construction as claimed in claim 1, wherein the partition element portion is designed as a single forged or cast metal portion.

10. A cubicle construction as claimed in claim 1, wherein the support portion comprises two upright portions for carrying the axis of rotation.

11. A cubicle construction as claimed in claim 3, wherein the closing element comprises a slotted hole, which slotted hole surrounds the closing element axis.

12. A cubicle construction as claimed in claim 11, wherein the closing element is shiftable along the closing element axis into a position in which rotation about the closing element axis is impeded or limited.

13. A cubicle construction as claimed in claim 1, wherein the partition element comprises a pair of free ends for connection to the support, each free end being provided with a coupling.

14. A cubicle construction for animals, comprising:
a support, extending in a first transverse direction along a plurality of animal places;
at least one partition element extending in a second longitudinal direction between adjacent animal places;
a coupling fastening the partition element to the support, the coupling comprising a support portion, a partition element portion and an axis lying generally in the transverse direction and allowing rotation of the partition element portion with respect to the support portion, wherein the partition element portion is detachable from the support portion via a movement of the partition element portion perpendicular to the axis of rotation; and
a closing element, movable to release the partition element portion from the support portion.

15. The cubicle construction as claimed in claim 14, wherein the partition element portion comprises a stop for limiting the movement in height of the partition element.

16. The cubicle construction as claimed in claim 15, wherein the support portion comprises a flexible bumper element that co-operates with the stop.

17. The cubicle construction as claimed in claim 14, wherein the partition element portion comprises a rotation space for surrounding the axis of rotation, which rotation space comprises an aperture at its lower side by which the partition element portion may be detached from the support portion.

18. The cubicle construction as claimed in claim 14, wherein the partition element comprises a pair of free ends connected to the support, each free end being provided with a coupling.

19. The cubicle construction as claimed in claim 18, wherein the partition element comprises a wishbone shaped member.

20. The cubicle construction as claimed in claim 13, wherein the partition element comprises a wishbone shaped member.
